(19) United States
(12) Patent Application Publication
(10) Pub. No.: US 2026/0320177 A1
(43) Pub. Date: Oct. 15, 2026

(54) SYSTEMS AND METHODS FOR DETERMINING SYSTEM SECURITY RISK ACTIVITY PATTERNS

(71) Applicants: AT&T Intellectual Property I, L.P., Atlanta, GA (US); AT&T Mobility II LLC, Atlanta, GA (US)

(72) Inventors: Amee Sheth, Brick, NJ (US); Ginger Chien, Bellevue, WA (US)

(73) Assignees: AT&T Intellectual Property I, L.P., Atlanta, GA (US); AT&T Mobility II LLC, Atlanta, GA (US)

(21) Appl. No.: 19/175,092

(22) Filed: Apr. 10, 2025

(51) Int. Cl. G06F 21/55; G06F 11/34

(52) U.S. Cl. CPC G06F 21/552; G06F 11/3438

(57) ABSTRACT

Aspects of the subject disclosure may include, for example, systems and methods for determining system security risk activity patterns. The systems and methods employ a processing system to collect data from various sources, including biometric sensors, applications, devices, and network access, to evaluate user activity against predefined patterns. These patterns include positive indicators of no intent to harm and negative indicators of intent to harm, assessed at both system-wide and per-user levels. The systems and methods generate codes indicative of acceptance, quarantine, or rejection based on this evaluation, dynamically adjusting as user behavior changes. Notifications are provided to stakeholders, specifying actions to mitigate identified threats. Other embodiments are disclosed.

### FIELD OF THE DISCLOSURE

The subject disclosure relates to systems and methods for determining system security risk activity patterns.

### BACKGROUND

Traditional security measures in protecting enterprise computing environments may have limit and room for improvement. Existing systems often rely on static encryption protocols and predefined algorithms, which may be difficult to adapt to evolving threats and changes in user behavior. Additionally, there is a limited use of behavioral analytics in security, typically focusing on anomaly detection rather than an adaptive response.

### BRIEF DESCRIPTION OF THE DRAWINGS

Reference will now be made to the accompanying drawings, which are not necessarily drawn to scale, and wherein:

FIG. 1A is a block diagram illustrating a prior art system.

FIG. 1B depicts an example, non-limiting embodiment of system security risk activity patterns in accordance with various aspects described herein.

FIG. 1C is a block diagram illustrating an example, non-limiting embodiment of a system functioning within the communication network of FIG. 1 in accordance with various aspects described herein.

FIG. 1D is a block diagram illustrating an example, non-limiting embodiment of another system in accordance with various aspects described herein.

FIG. 1E depicts an example, non-limiting embodiment of rulesets in accordance with various aspects described herein.

FIG. 1F is a block diagram illustrating an example, non-limiting embodiment of a system for a quarantined user in accordance with various aspects described herein.

FIG. 1G depicts an illustrative embodiment of a method in accordance with various aspects described herein.

FIG. 2 is a block diagram illustrating an exemplary, non-limiting embodiment of a communications network in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for determining system security risk activity patterns. The systems and methods determine system security risk activity patterns to enhance the security of protected systems by dynamically assessing user behavior. The systems and methods employ a processing system to collect data from biometric sensors, applications, devices, and network access, evaluating user activity against predefined patterns. These patterns are categorized into positive patterns, indicating no intent to harm, and negative patterns, suggesting intent to harm, assessed at both system-wide and per-user levels. The systems and methods generate codes for acceptance, quarantine, or rejection based on user activity evaluation, with these codes dynamically adjusting as user behavior patterns change. Notifications inform users, administrators, and security teams about identified risks and specify actions to mitigate threats. Artificial intelligence/machine learning models, including large language models, generate tailored questions to assess user intent and emotional state. The system captures environmental context data and employs feedback loops to refine patterns and update thresholds, providing a robust framework for managing security risks and protecting sensitive systems. Other embodiments are described in the subject disclosure.

One or more aspects of the subject disclosure are directed to a system including a plurality of sensors and a processing system. The plurality of sensors include biometric sensors operable to generate sensor output for a target user including a facial image, a fingerprint, a body temperature, a heartbeat rate, a movement speed, or a combination thereof, where the target user is an admitted user to a protected system by presenting a required credential for verification. The processing system includes a processor and a memory storing executable instructions that, when executed by the processor, facilitate performance of operations. The operations comprise collecting user behavior data of the target user corresponding to user behavior within the protected system during a predetermined time period, using the plurality of sensors including the biometric sensors and one or more usage patterns of the protected system; evaluating the user behavior data of the target user against predefined patterns stored in one or more databases, wherein the predefined patterns include a group of positive patterns indicative of no intent to harm the protected system and a group of negative patterns indicative of intent to harm the protected system, and wherein the group of negative patterns are determined based on publicly known historical data and user-specific historical data relating to harming computing systems; generating one of at least three codes indicative of acceptance, quarantine, and rejection of the target user based on the evaluation of the user behavior data; adjusting the codes dynamically as user behavior patterns change over time; and based on the generated one of the at least three codes, accepting, blocking, or quarantining access of the target user to the protected system.

One or more aspects of the subject disclosure are directed to a non-transitory machine-readable medium, comprising executable instructions that, when executed by a processing system including a processor, facilitate performance of operations. The operations comprise collecting user activity data of a target user within a protected system, using a plurality of sensors including biometric sensors, one or more applications used by the target user, one or more devices used by the target user, a network access by the target user, and based on responses by the target user to questions tailored to the target user; evaluating the user activity of the target user against predefined patterns stored in one or more databases, wherein the predefined patterns include a group of positive patterns indicative of no intent to harm the protected system at a system-wide level and a per-user level, and a group of negative patterns indicative of intent to harm the protected system at the system-wide level and the per-user level, and wherein the group of negative patterns are determined based on publicly known historical data and user-specific historical data relating to harming computing systems; generating one of at least three codes indicative of acceptance, quarantine, and rejection of the target user based on the evaluation of the user activity; adjusting the codes dynamically as user behavior patterns change over time; and based on the generated codes, accepting, blocking, or quarantining access of the target user to the protected system.

One or more aspects of the subject disclosure are directed to a method comprising collecting user activity data of a target user within a protected system, using a plurality of sensors including biometric sensors, one or more applications used by the target user, one or more devices used by the target user, a network access by the target user, and based on responses by the target user to questions tailored to the target user; evaluating the user activity data of the target user against predefined patterns stored in one or more databases, wherein the predefined patterns include a group of positive patterns indicative of no intent to harm the protected system at a system-wide level and a per-user level, and a group of negative patterns indicative of intent to harm the protected system at the system-wide level and the per-user level, and wherein the group of negative patterns are determined based on publicly known historical data and user-specific historical data relating to harming computing systems, and wherein the evaluating further comprises determining a match among the user behavior patterns and the group of negative patterns and the group of positive patterns; generating one of at least three codes indicative of acceptance, quarantine, and rejection of the target user based on the evaluation of the user activity data; adjusting the codes dynamically as the user activity data changes over time; and based on the generated codes, accepting, blocking, or quarantining access of the target user to the protected system.

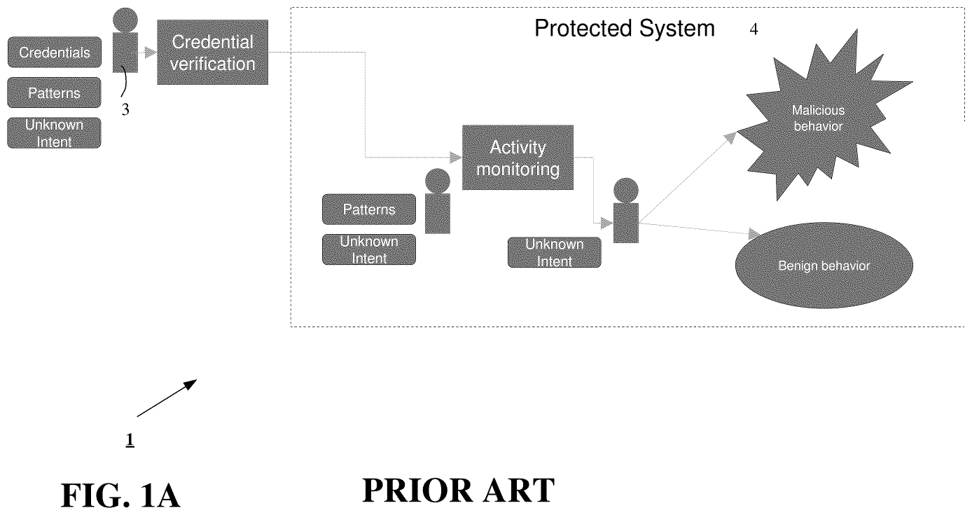

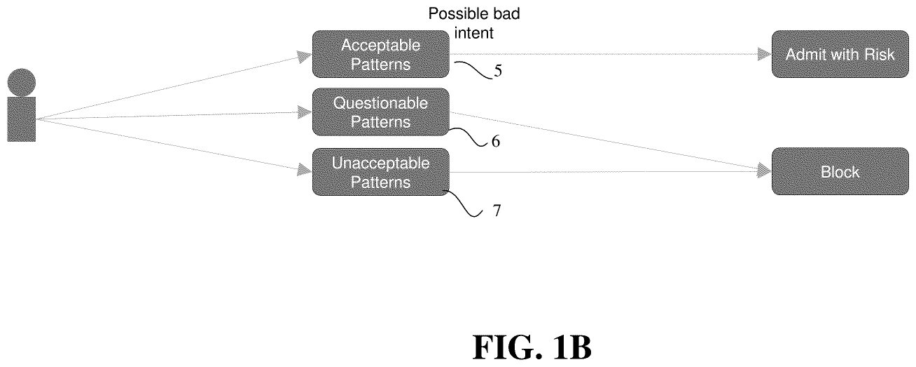

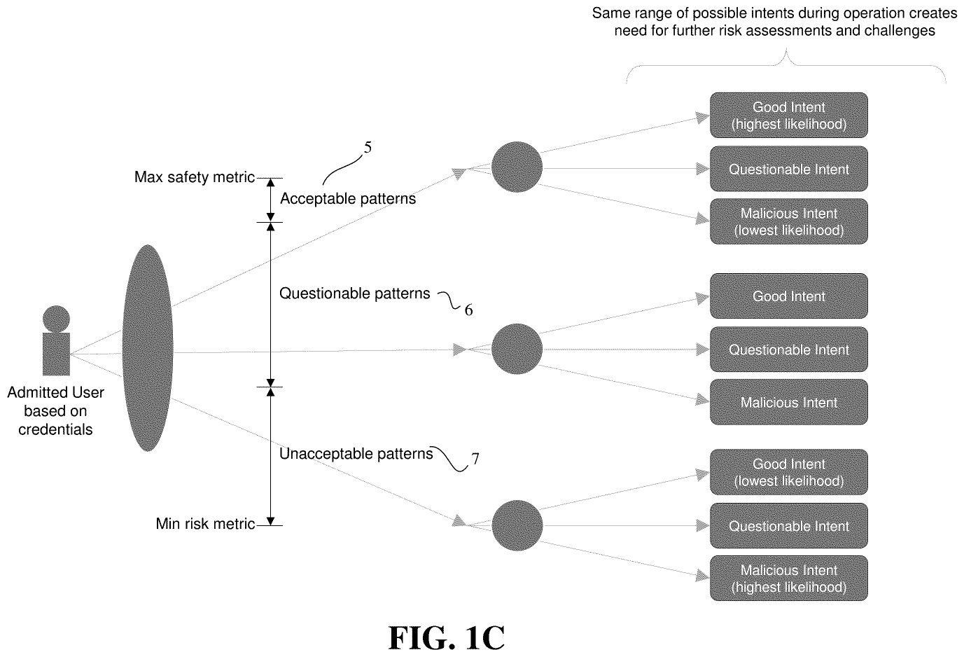

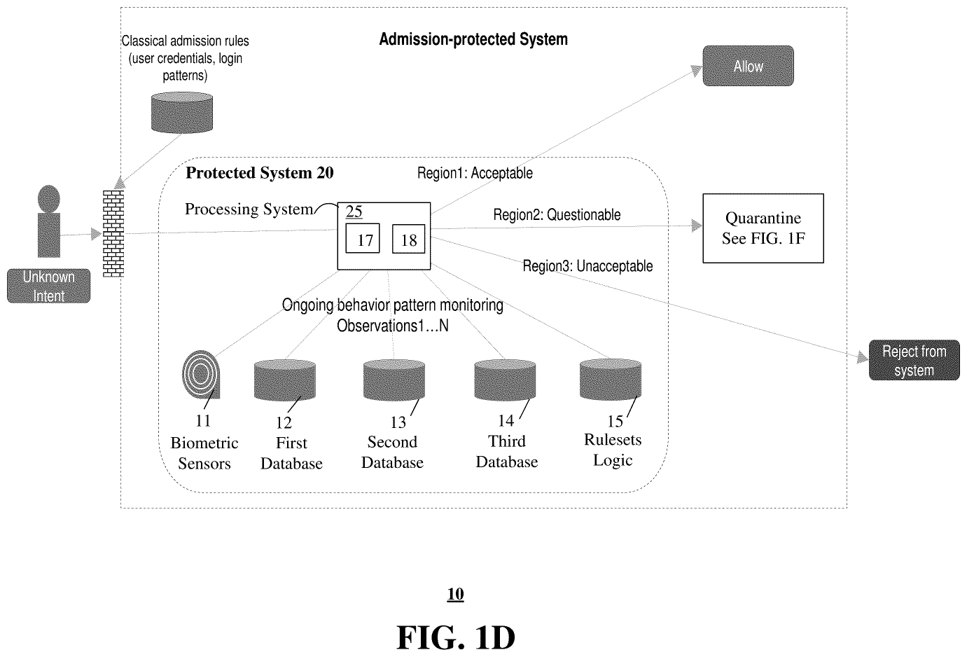

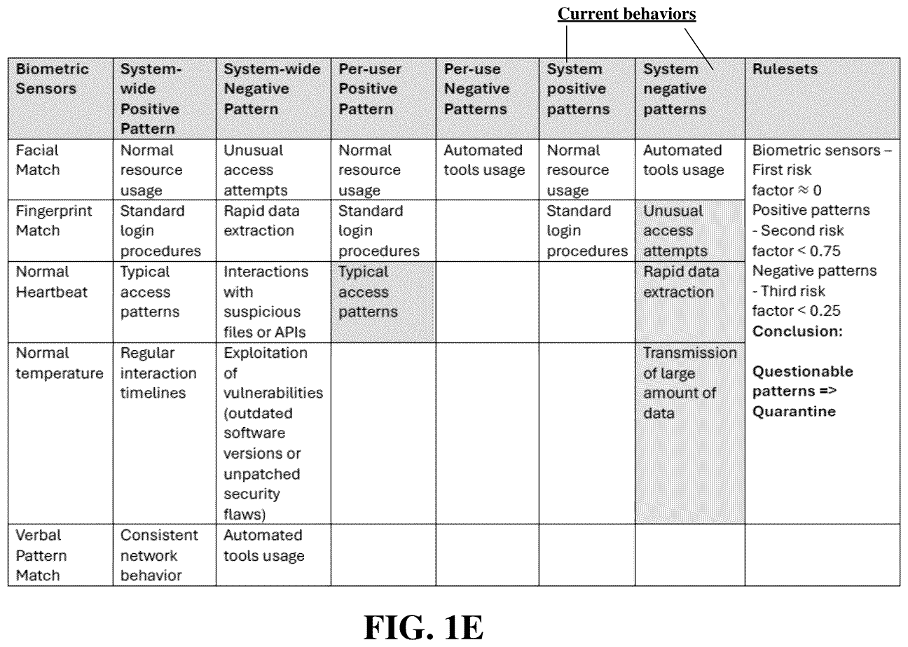

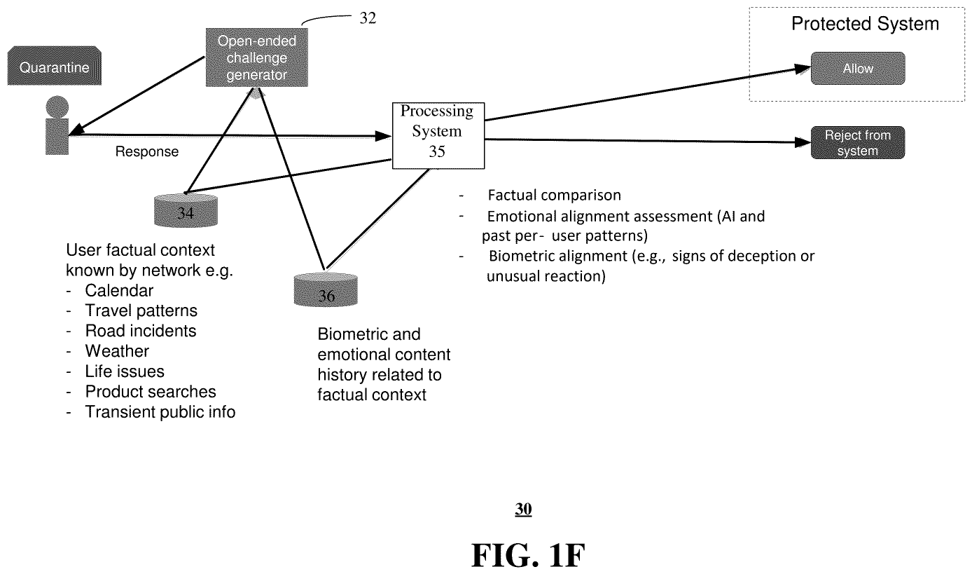

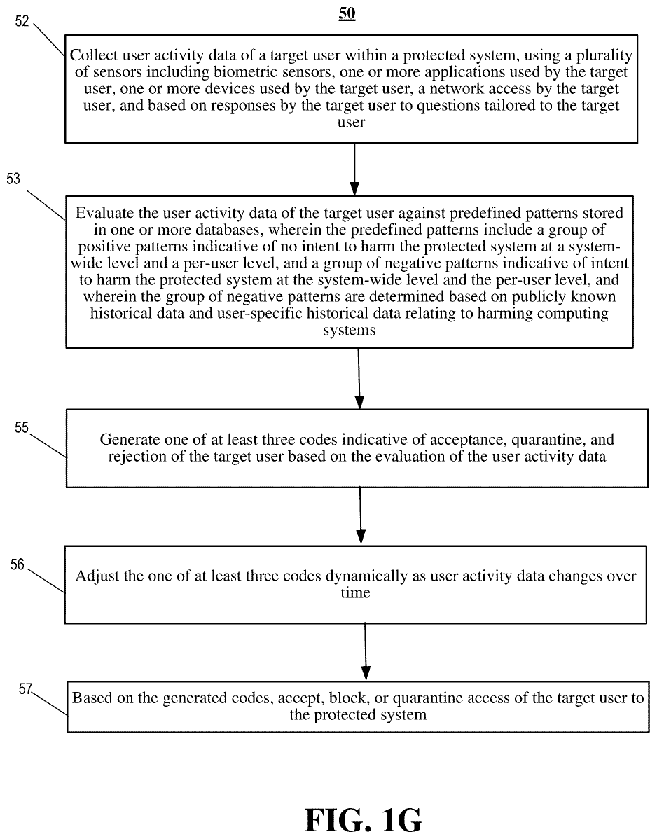

Referring now to FIG. 1A, a prior art system 1 is shown. The prior art system 1 checks for valid credentials of a user 3 who is associated with activity patterns and unknown intent. The user 3 may have an intent to damage a protected system 1, even though the user 3 has valid credentials. The user 3 also has certain activity patterns that impact or do not impact security of the protected system 4. In some cases, aggressive entry activity may still admit undesired actors into a system. The aggressive entry activity includes attempts to gain access to a system using methods that are forceful or persistent, potentially bypassing standard security measures. This can include repeated login attempts, exploiting vulnerabilities, or using automated tools to breach security protocols. Despite having valid credentials, such aggressive actions may indicate a malicious intent, as they often aim to penetrate the protected system's defenses and gain unauthorized access. Once admitted, undesired actors may hide within legitimate activity patterns. The system 1 may lack meaningful ability to explore suspicious activity patterns that will potentially impact security of the protected system 4. The system 1 may be further unable to periodically challenge borderline activity patterns to distinguish acceptable intent from unacceptable intent.

As depicted in FIG. 1A, the user 3 may be admitted into the protected system 4 by merely checking the credentials and completing credential verification. The user is subject to activity monitoring which presents certain patterns. However, the user 3 has an unknown intent which can be later resulting in malicious behavior that damages the protected system 4. In other words, observation of patterns do not discern underlying human behavioral causes such as too much coffee, emotional struggles, cyclical behaviors, etc. The observation of patterns further may not discern system reactions such as elevated file activity or memory events that reveal intent or emotional state of the user 3. For instance, an activity such as extremely fast and unusual typing speed may raise suspicion about the user 3, but such activity can be based on emotional struggle and not based on an intent to harm the protected system 4. On the other hand, an activity such as active performance during work hours includes downloading data that is not related to the user 3's job scope, which will potentially harm the protected system 4.

FIG. 1B depicts an example, non-limiting embodiment of system security risk activity patterns in accordance with various aspects described herein. As depicted in FIG. 1B, a user's activity in connection with enterprise computing systems can be associated with acceptable patterns 5, questionable patterns 6, and unacceptable patterns 7. The user's activity in connection with the enterprise computing systems is considered as being indicative of the user's intent that potentially harm the enterprise computing systems. For instance, the user's activity includes downloading a program that is known to have serious computer virus problems and such activity is associated with the unacceptable patterns indicative of negative intent that will harm the enterprise computing systems. Then the user's access to the enterprise computing systems will be blocked. For the same reason, the user's access to the enterprise computing systems can result in being blocked based on questionable patterns.

FIG. 1C is a block diagram illustrating an example, non-limiting embodiment of association between patterns and intent of admitted user of an enterprise computing system in accordance with various aspects described herein. As described in FIG. 1B, an admitted user's activities can be categorized into acceptable patterns 5, questionable patterns 6, and unacceptable patterns 7. Artificial intelligence/machine learning (AI/ML) techniques available in the pertinent field, based on supervised training of normal baseline patterns of network, resource, address, application program interfaces (APIs), file types/sizes/locations, logs, and similar observable usage/activity characteristics (can also include signatures of data, commands, and payloads) can be used in determining the categories of the patterns, supplemented by AI/ML models trained against broader patterns to have predictive and adaptive detection capability. AI/ML models can function as detection/alarm models, where thresholds for alarms are defined. Ranges of observable behavior can be categorized by risks. A tighter, safer, more conservative range of acceptable behavior is defined in light of a quarantined follow-up which will set forth in detail below in connection with FIG. 1F.

In a simple decision model, a one-dimensional risk scale may be defined, e.g. from 0 to 1. As depicted in FIG. 1C, higher metrics may correspond to higher safety and less risk. A threshold may be defined such that a binary decision is made to accept users if safety metrics are >0.95 and reject users if the safety metrics are <0.95. More confidence in an admitted user (and less monitoring) may be defined for 0.97-1.0 by way of example only, a questionable range may exist from 0.90-0.97 to improve the chance of providing desired service for what would have been a barely unaccepted user under the binary model, and 0.0-0.90 would be a higher confidence rejection range with less risk of unwarranted rejection. Multivariable rules can carve the decision space into any number of desired tiers or spatial zones for better discernment of unique risk relationships among observed variables.

In some embodiments, these patterns are defined with a predetermined scale based on various parameters relevant to the enterprise computing system. For instance, an enterprise is a hospital and unacceptable patterns and questionable patterns to the computing system thereof can be broadened, as opposed to an enterprise such as a calorie counter service which does not involve life threatening situations. As another example, an enterprise is a financial institution, and acceptable patterns to the computing system can be stricter than other industries such as a free entertainment service, in light of importance of security and privacy issues. As depicted in FIG. 1C, acceptable patterns, questionable patterns, and unacceptable patterns are associated with a group of intent including positive intent, questionable intent, and malicious intent, respectively.

In various embodiments, intent may be unknowable and can be predicted based on observable behaviors. However, an overt or more reliably inferred statement of negative intent may be detected in an open-ended challenge, e.g., anomalous responses well outside the norm, biometrics that reflect an immediate fear of being caught reaction, explicit statements of negative intent if actually revealed, etc. which will potentially lead to a high confidence denial of access. Less confident risk determinations steer toward other categories of intent.

Historical data can be used to correlate known past intrusions/attacks with correlated behavior indicative of such instructions/attacks. If correlation is difficult, alternative detection and alarming can be achieved with AI/ML models, trained on a large volume of historical data that combines previously mentioned behaviors (network, resource, address, API, file types/sizes/locations, logs, and similar observable usage/activity characteristics; can also include signatures of data, commands, and payloads) to deliver a predictive and less rigidly deterministic detection logic. Available techniques as to how to train and execute such detection algorithms can be used. Furthermore, AI interpretation of the open-ended challenge responses can be used to detect suspicious responses similar to Turing Tests (detecting bots), Generative AI (Gen-AI) tests (i.e., detecting Gen-AI output), biometrically-revealed deception (pupil dilation or eye movements during a lie, faster breathing), biometric deviation from authenticated user norms (different keystroke timing), where risky conditions can be alarmed with system-definable false alarm/miss rates.

FIG. 1D is a block diagram illustrating an example, non-limiting embodiment of a system 10 in accordance with various aspects described herein. The system 10 is operable to determine system security risk activity patterns by a user who has been admitted into a protected system 20 in an enterprise computing system. The user has been admitted into the protected system 20 with valid credentials such as authorized log-in information, two-way authentication, etc., but such entry does not guarantee that the user has no intent to harm the protected system 20. For instance, the user can be a disgruntled employee who plans to leave an enterprise and prior to departure, the user has developed intent to harm the protected system 20.

In various embodiments, data relating to the user's activity in connection with the protected system 20 is collected. The system 10 includes a biometric sensor 11 that collects data relating to the user's activity. The biometric sensors 11 capture biometric data of the user including fingerprints, facial recognition, other physiological characteristics, etc. and verify an identity of the user. The biometric sensors 11 further determine abnormal heart conditions, body temperature of the user, other physical abnormality, etc. that are relevant data to the determination of the user's activity.

The system 10 further includes a plurality of databases 12, 13 and 14. A first database 12 stores positive system-wide patterns and negative system-wide patterns that have been collected based on historical events and historical data. A second database 13 stores positive per-user patterns and negative per-user patterns. A third database 14 stores current positive and negative system patterns by the user.

In one or more embodiments, the use of positive and negative patterns, as opposed to patterns therebetween, facilitate a determination for clear and decisive actions in security systems. Positive and negative patterns represent a clear boundary of user behavior, where the intent and risk level are more easily identifiable. These patterns allow the system 10 to focus on a small dataset corresponding to the positive and negative patterns (as opposed to a large dataset corresponding to the patterns therebetween), thereby making high confidence decisions about user behavior or activities and either allowing or blocking users based on their behavior alignment with these patterns.

By way of example only, a distribution pattern of user behavior or activities can be expected to follow a normal, Gaussian distribution, although the present disclosure is not limited to the Gaussian distribution and other statistical distributions having different distribution shapes than a bell curve may be used. An empirical or formulaic statistical distribution can be fitted with past observations to assess whether a recent behavior is excessively anomalous. In a Gaussian distribution, most data points cluster around the mean, forming a bell-shaped curve. When applied to human behavioral patterns, the Gaussian distribution can be used to model the variability and frequency of certain behaviors within a population. Human behaviors often exhibit a range of expressions, with most individuals displaying average or typical behaviors, while fewer individuals exhibit behaviors that are significantly above or below the average. This results in a distribution of behaviors that can often be approximated by a Gaussian curve. For example, with respect to a behavioral trait such as adherence to rules or laws, most people tend to follow societal norms and legal regulations, resulting in a clustering of behaviors around the mean, which represents law-abiding behavior. However, there are individuals who may deviate from this norm, either by strictly adhering to rules or by violating them. These deviations create the tails of the distribution, where fewer individuals are found. This may be aligned with historical patterns and observations indicating that most user behaviors fall into a gray area, where intent is not immediately discernable to take a definite action such as allowing or blocking users for the protected system 20. The tails of the distribution, representing the positive and negative patterns, contain fewer but discernable data points for identifying behaviors that are significantly different from the behaviors falling into the gray area.

Referring back to FIG. 1D, the Gaussian distribution can be applied to model user behaviors within the protected system 10. Positive patterns, which cluster around the mean, indicate behaviors that show no intent to harm the system, such as regular access to resources and adherence to security protocols. These behaviors are typical and expected, representing the majority of users who interact with the system safely. Conversely, negative patterns, found in the tails of the distribution, indicate behaviors that show a clear intent to harm the protected system. These may include unusual access attempts, rapid data extraction, or interactions with suspicious files or APIs. Identifying these negative patterns allows the system to take appropriate security measures, such as blocking or quarantining users, to protect against potential threats. By focusing on these patterns, the system 10 can effectively discern user intent and enhance its security framework. Accordingly, focusing on positive and negative patterns enables the system 10 to establish benchmarks for what is considered safe behavior or risky behavior. These benchmarks define the thresholds at which the system 10 can confidently categorize user actions as either acceptable or unacceptable.

By identifying and acting on these clear patterns, the system 10 can reduce the complexity and ambiguity associated with the majority of behaviors that fall in the middle of the distribution. This approach allows for more efficient and effective security measures, as the system can prioritize resources and attention on the most critical cases. The system 10 further checks into questionable patterns through additional mechanisms, such as open-ended challenges or further monitoring, as will be set forth below in detail.

In one or more embodiments, the first database 12 is configured to store high confidence positive/negative system-wide patterns including established behavioral patterns. The established behavioral patterns have been identified and validated across a wide range of users and systems, providing a reliable basis for assessing user intent and risk. These patterns are derived from historical data and extensive analysis, capturing typical behaviors that are consistently associated with either benign or malicious activities. High confidence positive system-wide patterns represent behaviors that are indicative of legitimate and safe user interactions, such as normal resource usage, standard login procedures, and typical access patterns. Normal resource usage indicates consistent access to system resources, such as files and applications, that aligns with typical user behavior and does not exceed expected thresholds. Standard Login Procedures indicate regular login activities that follow established protocols, such as using correct credentials and two-factor authentication, without any unusual attempts or failures. Typical access patterns indicate accessing data and services in a manner that is consistent with the user's role and responsibilities, without any deviations that might suggest unauthorized activity. Regular interaction timelines indicate that user activities that occur within expected time frames, such as accessing the system during standard working hours and following typical usage patterns. Consistent network behavior indicates network interactions that match known safe patterns, such as accessing familiar IP addresses and domains, and maintaining expected data transfer rates.

These positive system-wide patterns serve as benchmarks for the system to evaluate current user behavior, allowing it to identify and confirm legitimate activities more effectively. By recognizing these patterns, the system 10 can make informed decisions about whether to admit, monitor, or allow users to continue their activities with minimal interference.

Conversely, high confidence negative system-wide patterns are associated with known malicious activities, such as unusual access attempts, rapid data extraction, interactions with suspicious files or Application Program Interfaces (APIs), exploitation of vulnerabilities, automated tools usage, etc. Unusual access attempts indicate repeated or unauthorized attempts to access restricted areas of a system, which may indicate an attempt to breach security protocols. Rapid data extraction may involve high-volume data transfers or downloads that occur in a short period, suggesting potential data theft or exfiltration. Interactions with suspicious files or APIs may involve accessing or executing files known to be associated with malware or interacting with APIs in a manner that deviates from normal usage patterns. Exploitation of vulnerabilities may involve attempts to exploit known system vulnerabilities, such as using outdated software versions or unpatched security flaws. Automated tools usage may involve the use of automated scripts or tools to perform actions that mimic legitimate user behavior but at a scale or speed that is atypical for human users.

These negative system-wide patterns serve as benchmarks for the system 10 to evaluate current user behavior, allowing it to identify and respond to potential threats more effectively. By recognizing these patterns, the system 10 can make informed decisions about whether to admit, quarantine, or block users, thereby enhancing overall security measures.

Based on the above, the system 10 uses these system-wide patterns stored in the first database 11 as benchmarks or a reference to evaluate current user behavior, allowing it to make informed decisions about whether to admit, quarantine, or block users based on their alignment with these patterns. By leveraging high confidence system-wide patterns, the system 10 can more accurately predict user intent and enhance security measures, reducing the likelihood of false alarms and improving the detection of potential threats.

In one or more embodiments, the second database 13 is configured to store high confidence positive/negative ‘per user’ patterns. As opposed to the system-wide patterns in the first database 12, the per-use patterns are directed to individual user's traits or characteristics and can be unique or distinctive. By way of example only, the second database 13 may store information such as accessing data directed to a particular subject matter relevant to a user's role, a preference to application tools, extremely fast typing speed, etc. If a user's activity deviates from the per user pattern thereof, such as extremely fast typing speed to extremely low typing speed, a questionable or unacceptable pattern may be determined.

High confidence positive/negative per user patterns are specific behavioral patterns associated with individual users, derived from their historical interactions with the system 10. These patterns are tailored to each user, reflecting their typical behaviors and interactions, and are used to assess the user's intent and risk level more accurately. In particular, high confidence positive per use patterns represent behaviors that are consistent with a user's normal, legitimate activities, such as regular login times, typical resource usage, and standard access patterns. These patterns indicate a low risk of malicious intent and are used to facilitate smoother access and reduced monitoring for the user. On the other hand, high confidence negative per use patterns are indicative of behaviors that deviate significantly from a user's norm and are associated with potential malicious activities. These may include unusual access attempts, accessing sensitive data not typically used by the user, or other anomalies that suggest a higher risk of malicious intent.

By maintaining a database of these per user patterns, the system 10 can compare current user behavior against these benchmarks to make informed decisions about access and monitoring. This approach allows for a more personalized and accurate assessment of risk, enhancing the system 10's ability to detect threats while minimizing false positives.

The third database 14 is configured to store high confidence ‘current’ positive/negative system patterns, which refer to current patterns of interaction within a specific system that are used to evaluate the intent and risk associated with user activities. These patterns capture current, ongoing behaviors of users that are consistently associated with either benign or malicious activities within the specific system's context. The current system patterns may capture repeated behaviors of users on a daily basis. The patterns include, for example, hard drive access, CPU subsystem power usage, cache activity, etc.

By way of example, high confidence current positive system patterns represent interactions that align with the expected and legitimate use of system resources, such as standard data access protocols, typical file operations, and normal network usage. These behaviors indicate a low risk of malicious intent and are used to facilitate seamless access and operation within the system. Conversely, high confidence current negative system patterns are indicative of interactions that deviate from the norm and are associated with potential security threats. These may include unusual access patterns, rapid data extraction, or interactions with suspicious files or APIs that suggest a higher risk of malicious intent.

In some embodiments, a data collection event or session can take place on a daily basis. An open-ended challenge is a mechanism used within the system 10 to assess intent of users. As one example, the open-ended challenge may focus on particularly those who fall into the questionable category or are quarantined due to suspicious behavior. Additionally, or alternatively, the open-ended challenge is used as a data collection event or session in order to collect data indicating or assessing intent of users. This approach includes presenting users with questions or tasks that require them to provide responses that can be analyzed for consistency, emotional content, and alignment with known user patterns.

The open-ended challenge is designed to elicit factual, emotional, and biometric information in real-time, going beyond static and previously known attributes of the user. For example, users might be asked to describe recent activities or experiences, such as “Details and feelings of lunch with your mother-in-law?” or “Details and feelings of your most recent drive?” These questions are crafted to assess the user's emotional state, contributing to assessing or explaining the user's particular activity on a particular day, especially when the user's particular activity is deviated significantly from the user's activity patterns stored in the second database 13. Additionally, the open-ended challenge can be used to verify their identity through their responses.

When the system 10 assigns “acceptable” or “unacceptable” to an observed behavior, there is a given risk that it is incorrectly assigned. The cost of a wrong decision varies by situation but with just one threshold defining the 2 outcomes, there can be significant incorrect decisions if the actual statistical distributions of acceptable and unacceptable behaviors overlap significantly thus masking the intent and increasing the risk of a wrong decision. Wrong decisions could come with sizable cost (high inconvenience vs. high risk for example). The multi-tiered decision thresholds give us the ability to narrow the acceptable and unacceptable determinations with greater reliability that they are correct on the initial decision. At least one questionable partition between the acceptable and unacceptable determinations may be generated where the cost of a wrong decision may not be risked either way and would rather take a moment to challenge users with open-ended questions, thus allowing them to maintain quarantined presence in the system 10 for various advantageous reasons such as maintaining the state of their work without being rejected.

Additionally or alternatively, various sensors and mechanisms can be used to detect or track users' activities relating to the enterprise computing system. As one example, software applications or devices (e.g., a computer mouse, a camera, a microphone, etc.) are used to detect or track user's activities, such as a prolonged idle time, extremely fast typing speed, repeated login attempts or failure, accessing to a large number of files in a short time window, extended period of absence of verbal communications, delayed responses to chats or messages, etc.

In one or more embodiments, the system 10 includes a processing system 25 having a processor 17 and a memory 18 for storing executable instructions thereon. The processing system 25 accesses and executes a rulesets logic 15 and generates outputs such as Region 1 (the user activities acceptable), Region 2 (the user activities questionable), and Region 3 (the user activities unacceptable). The outputs are followed by different actions, i.e., allowing the user to continue to access the enterprise computing system, blocking the access, or quarantine the user's access.

In one or more embodiments, the processing system 25 is responsible for generating codes that correspond to different regions of user behavior: Region 1 (Acceptable), Region 2 (Questionable), and Region 3 (Unacceptable). The present disclosure is not limited thereto and in other embodiments, more codes than three regions can be generated as needed. These codes are used to categorize user activities based on their alignment with predefined patterns and risk levels. The processing system 25 evaluates ongoing behavior pattern monitoring data, utilizing inputs from biometric sensors, databases, and rulesets logic to assess the user's actions. Based on this assessment, the processing system 25 generates codes that indicate the user's current status within the protected system. Region 1 codes signify that the user's behavior is deemed acceptable, allowing continued access with minimal interference. Region 2 codes indicate questionable behavior, prompting further monitoring or challenges to verify intent. Region 3 codes represent unacceptable behavior, leading to actions such as blocking or quarantining the user. These codes are dynamic and can change as user behavior patterns are determined to evolve. The processing system 25 continuously analyzes new data and adjusts the codes accordingly, ensuring that the processing system 25 remains responsive to changes in user activity. This adaptability allows the processing system 25 to maintain accurate assessments of user intent and risk, providing a robust framework for security management.

The processing system 25 in FIG. 1D is operable to generate outputs that notify various stakeholders, including users, system administrators, security teams, and management. These notifications serve multiple purposes, informing users of the monitoring of their activities and encouraging them to stay focused on work-related tasks. For users, such notifications can act as reminders to maintain productivity and adhere to acceptable behavior patterns.

For system administrators, security teams, and management, the notifications provide alerts about potential risks or deviations from normal behavior patterns. These alerts enable the security teams and management to prepare for potential damage to the protected systems and take necessary actions. Such actions may include issuing warnings to users who exhibit questionable or unacceptable behavior patterns or, conversely, complimenting users for positive work-related behaviors that align with the organization's security protocols.

By providing timely and actionable notifications, the processing system 25 enhances the overall security framework, ensuring that all stakeholders are informed and can respond appropriately to any potential threats or commendable behaviors. This proactive approach helps maintain a secure and efficient operational environment.

In one or more embodiments, the rulesets logic 15 is configured to stores rulesets for various situation and corresponding threshold table(s). These rulesets define predefined criteria that categorize user activities into acceptable, questionable, and unacceptable patterns, for various situations involving user activities or user behavior patterns relevant to the enterprise computing system. Referring to FIG. 1D, user behavior patterns are being monitored on an ongoing basis, periodically or at a predetermined interval, etc.

Using the example described above in connection with FIG. 1C, the rulesets logic may be configured to reject the user if the risk is <0.95, where risk thresholds range from “0” to “1,” where “1” indicates extremely low risk and “0” indicates extremely high risk. The rulesets are configured to define specific thresholds for different risk levels with respect to different user activities or behavior patterns. The rulesets are designed to be adaptable and context-specific, allowing the system to tailor its security measures to the unique needs of different environments. For example, in a hospital setting, the rulesets might be broader not to delay or impact life-threatening situations, whereas in a financial institution, they might be stricter due to the high importance of security and privacy. These rulesets work in conjunction with threshold tables to evaluate the risk associated with observed behaviors.

FIG. 1E illustrates one example, non-limiting embodiment of the rulesets logic 15 in accordance with various embodiments described herein. The example illustrated in FIG. 1E is by way of example only and the present disclosure is not limited thereto. As depicted in FIGS. 1D and 1E, the user's activities or behavior patterns as current system positive patterns, and current system positive patterns, are compared and assessed against system-wide positive patterns, system-wide negative patterns and per-user positive patterns, per-user negative patterns. As depicted in FIG. 1E, data detected by the biometric sensors 11 indicate facial match, fingerprint match, normal heartbeat rates, normal temperature, and verbal pattern match. In FIG. 1E, the user's activities are determined not to be squarely aligned with per-user positive patterns, in particular, deviated from typical access patterns. The user's activities are determined to match with several system-wide negative patterns.

In some embodiments, the rulesets logic 15 is configured to assess the user activities, in particular, matches of the user activities with system-wide positive patterns and per-user positive patterns and matches of the user activities with system-wide negative patterns and per-user negative patterns. The ruleset logics 15 may employ historical data indicating activity patterns and associated events that took place. For instance, historical data can show that matches with ten system-wide negative patterns and five system-wide positive patterns has resulted in damage to the protected system 20. As another example, a single match with a particular system-wide negative pattern has resulted in damage to the protected system 20. The ruleset logics 15 is configured to define first correlation between a match of the user activities with the system-wide positive patterns and the per-user positive patterns and Region 1 (acceptable). The ruleset logics 15 is configured to define second correlation between a match of the user activities with the system-wide negative patterns and the per-user negative patterns and Region 3 (unacceptable). The first correlation and the second correlation may be quantified in order to be compared with a specific threshold set by the rulesets logics 15.

Based on the above, the rulesets logics 15 is further configured to define criteria which weighs the match with data from the biometric sensors, the first correlation, and the second correlation and determines which region the user activities will land, among Region 1 (Acceptable), Region 2 (Questionable), or Region 3 (Unacceptable). The rulesets logics 15 can be set up such that if the user's activities includes the system positive patterns only which match with the system-wide positive patterns and the per-user positive patterns, the user's activities will land in Region 1 (Acceptable). The rulesets logics 15 can also be set up such that if the user's activities includes negative matches that outweighs positive matches, the user's activities will land in Region 2 (Questionable). The rulesets logics 15 can further be set up such that if the user's activities primarily includes matches with the negative patterns and additionally deviates from the per-user's positive patterns, the user's activities will land in Region 3 (Unacceptable). The ruleset logics 15 can be set up such that if the biometric sensor data indicates abnormality or deviation from the user's normal condition (abnormally fast heartbeat, face unrecognizable, etc.), the user's activities will land in Region 2 or Region 3. The rulesets logics 15 may be configured to determine weights applied to each of the negative patterns and the positive patterns stored in the first database 12 and the second database 13 and matches with each negative pattern and each positive pattern can be calculated as weighted values. As further another example, the rulesets logics 15 may be configured to add weighted values for positive matches and subtract weighted values for negative matches and determine that a final value is more or less than a threshold such as 0.95 out of 1, which is Region 3, 0.95~0.97 (Region 2), and more than 0.95 (Region 1).

In one or more embodiments, the rulesets logics 15 may be implemented using artificial intelligence/machine learning (AI/ML). For instance, to calculate the correlation between input patterns (i.e., the user activities patterns) and predetermined classifications (i.e., acceptable, unacceptable and questionable), a supervised learning approach may be employed. This involves training a model on labeled data where the input patterns are associated with specific classifications.

Using the example depicted in FIG. 1E, several patterns match with system-wide negative patterns (e.g., unusual access attempts, rapid data extraction), several pattern match with system-wide positive patterns (e.g., normal resource usage, standard login procedures), a system negative pattern that does not match with the system-wide negative pattern, a system negative pattern that matches with the per-user negative pattern (e.g., transmission of large amount data) may be used as input patterns to an AI/ML model. Historical data including corresponding classifications (e.g., positive, questionable, negative) with respect to the each pattern are gathered.

Data preprocessing is performed to ensure that the input data is clean and formatted correctly. This may include normalization, handling missing values, and feature extraction. For feature engineering, relevant features are extracted from the input patterns that can be used to train the model. By way of example only, this may include statistical measures, frequency counts, or other domain-specific metrics. For instance, each match count between the current system positive/negative patterns and the system-wide positive/negative patterns, and each match count between the system positive/negative patterns and the per-user positive/negative patterns, are extracted. Moreover, system positive/negative patterns that have no match with the system-wide positive/negative patterns and the per-user positive/negative patterns are extracted.

In various embodiments, Artificial intelligence/Machine learning (AI/ML) model selection follows. A suitable machine learning model is selected for classification. By way of example only, AI/ML models may include decision trees, random forests, support vector machines (SVM), or neural networks, depending on the complexity and size of the dataset. The selected AI/ML model is trained to split the data into training and testing sets. The model is trained using the training set, where the input patterns are mapped to their classifications. The model learns to identify correlations between features and classifications. The AI/ML model's performance using the testing set is evaluated. Metrics such as accuracy, precision, recall, etc., can be used to assess how well the model predicts classifications. Once the AI/ML model is trained, it can be used to calculate the correlation between new input patterns and the predetermined classifications. This involves providing new data into the model and observing the predicted classifications.

By defining specific thresholds for different risk levels, the system 10 can make informed decisions about whether to admit, quarantine, or block users. The system 10 may make a more nuanced assessment of user intent, moving beyond a simple binary decision model to incorporate a spectrum of risk categories. The use of the rulesets logic 15 enables the system 10 to dynamically adjust its security protocols based on real-time data and historical patterns. By leveraging these rulesets logic 15, the system 10 can better discern unique risk relationships among observed variables, enhancing its overall security posture and providing a more robust defense against potential threats.

FIG. 1F is a block diagram illustrating an example, non-limiting embodiment of a system 30 for a quarantined user in accordance with various aspects described herein. The system 30 is configured to verify a temporary state of the user and ultimately determine that the quarantined user should be allowed or rejected from a protected system. The system 30 includes an open-ended challenge generator 32 which generates questions to be used in open-ended challenges. The open-ended challenges are used for quarantined users at an intensity (difficulty of questions, more numbers of questions) appropriate for the 1 or more risk levels within the quarantined family of risk determinations. The open-ended challenges may enhance its ability to discern user intent, providing a more nuanced and accurate assessment of risk. This approach allows for more refined decisions regarding user access and monitoring, improving the overall security framework by reducing false positives and ensuring that potential threats are effectively identified and managed.

In FIG. 1F, the open-ended challenge generator 32 is responsible for generating questions designed to elicit factual, emotional, and biometric information in real-time. This generator utilizes an AI/ML model to craft questions that are tailored to the specific context and user history. The AI/ML model employed by the open-ended challenge generator 32 can leverage advanced techniques, such as large language models (LLMs), to create questions that are both relevant and insightful. LLMs are capable of understanding and generating human-like text based on vast amounts of training data. LLMs analyze user data, historical interactions, and known patterns to formulate questions that probe deeper into the user's intent and emotional state. For example, the open-ended challenge generator 32 may use an LLM to create a question like, “Can you describe your recent experience with [specific event] and how it made you feel?” This question is designed to assess the user's emotional response and verify their identity through the consistency of their answers. By employing LLMs, the open-ended challenge generator 32 ensures that the questions are dynamic, context-aware, and capable of revealing subtle cues about the user's intent.

The system 30 includes a fifth database 34 which stores known data about a quarantined user (known factual content, related emotional history) which is available for use by the AI/ML model used in the open-ended challenge generator 32 to generate open-ended challenge questions. The system 30 further includes a sixth database 36 which stores biometric and emotional content history related to factual context. For example, a calendar marks a passing of a close family member and a biometric sensor detects a low heartbeat rate or there was an event that revealed emotional state of the user on the date of passing.

The AI/ML model used in the open-ended challenge generator 32 accesses the user factual context known by the network, which is stored in the fifth database 34, to generate tailored questions that assess user intent and emotional state. The AI/ML model integrates various data sources to build a comprehensive profile of the user's factual context, including information such as calendar events, travel patterns, road incidents, weather conditions, life issues, product searches, and transient public information like accidents, traffic situations, and economic conditions. The AI/ML model may further analyze this integrated data to understand the user's current environment and potential influences on their behavior. For instance, the AI/ML model may consider how recent travel disruptions or adverse weather conditions could impact the user's emotional state or actions.

Using the insights gained from the contextual analysis, the AI/ML model formulates questions that are relevant to the user's current situation. These questions are designed to probe deeper into the user's experiences and emotional responses. For example, if the user recently experienced a travel delay due to a road incident, the AI/ML model may generate a question like, “How did the recent traffic delay affect your plans and mood?” The AI/ML model continuously updates its understanding of the user's context as new data becomes available, allowing the open-ended challenge generator 32 to adapt the questions in real-time, ensuring they remain pertinent and insightful.

Additionally, the AI/ML model considers the emotional content history related to the factual context, which is stored in the sixth database 36, when generating questions. For instance, if a user has historically shown much slower typing speed or inactive performance during cold or rainy days, the AI/ML model may generate questions that explore these patterns, such as “How does the current weather affect your productivity today?” By incorporating both factual context and emotional content history, the AI/ML model can create questions that provide a deeper understanding of the user's behavior and emotional state.

In addition to probing consistency of experiences and emotional responses, the AI/ML model also compares to facts. For example, “how did the recent traffic delay affect your plans and mood” is not very open-ended because a likely correct response may be guessed based on the hint of traffic delay (e.g., “I arrived later than I wanted and was angry”). Based on the actual road conditions that may have allowed either a remarkably fast or slow commute, a more useful question can be “what was your mood after your commute to the office?”, for example.

In FIG. 1F, the processing system 35 is designed to receive responses to questions generated by the open-ended challenge generator 32. Upon receiving these responses, the processing system 35 undertakes several analytical tasks to assess the user's intent and determine the appropriate action. The processing system 35 performs a factual comparison by evaluating the user's responses against known data and facts about the user's context, checking the consistency and accuracy of the information provided.

Additionally, the processing system 35 conducts an emotional alignment assessment based on past per-user patterns, analyzing the emotional content of the user's responses and comparing it to historical emotional data associated with the user. This helps identify alignment or deviations from typical emotional responses, providing insights into the user's current state and intent.

The processing system 35 also performs biometric alignment, analyzing biometric data such as voice stress, typing speed, or other physiological indicators captured during the challenge. This analysis helps to identify any signs of deception or unusual reactions that might indicate a security threat.

Using these analyses, the processing system 35 generates a determination on whether to allow the quarantined user to continue accessing the system or to reject their access. The processing system 35 can employ an AI/ML algorithm to enhance its decision-making capabilities. This algorithm can predict the user's intent to harm the protected system or not, based on the user's responses to questions and historical data relating to the user or other users showing similar responses and behaviors. The accuracy of this prediction can be enhanced by various parameters, such as the size of datasets, the relevance of datasets used for training, and the sophistication of the AI/ML model. By leveraging AI/ML, the system can improve the accuracy and reliability of its assessments, learning from past interactions and continuously refining its ability to discern user intent and potential threats.

In one or more embodiments, the open-ended challenges can be used periodically for fully admitted and accepted users as a stronger form of an “are you still there?” challenge during a stale session. The open-ended challenges can also be used in the special case of a rejected user who is actually isolated in a logical computing space honeypot or physically isolated honeypot to explore the attacker. Intent is predicted by the quality of answers and degree of knowledge of facts. Negative day would eventually have a history of negative days to compare to. Negative day can also be temporarily allowed or added as a temporarily persistent or permanent expansion of acceptable patterns (by system policy) for the user after successfully passing the challenges. Initial thresholds can be trained on historical patterns, especially actual past threats, such that the reliability of detection meets system goals (likely set to detect all past threat patterns plus some more unknown ones).

The emotional variability reveals itself as a wider deviation around norms, i.e. if the user has high emotional regulation, there would be little correlation of input conditions like events and challenge questions to outputs like stable responses/biometrics. If there is situational variation that affects ongoing behaviors, it can move the user into the Questionable category. It is this wider variation of behavior that gets explored with the open-end challenges to reconfirm knowledge of facts and consistency with past responses in tone/content. There are various ways to learn about the user and build patterns to compare with a system-known scheduled lunch with mother-in-law. The open-ended challenge generator 32 may learn a pattern consistent with past frustrating lunches with mother-in-law and ask about the participants in the lunch and sentiment to look for consistency (user identifies lunch was with the mother-in-law). The open-ended challenge may result in the user identifying lunch was with the son of the mother-in-law and frustration with their defense of mother-in-law which is acceptably consistent. The system 30 may detect that the lack of movement showed a meeting in the office that ran long to detect a (negative actor) lie about having lunch with mother-in-law.

Sophisticated AI capability used in the processing system 35 may detect questionable behavior based on historic patterns and correlated causes, to detect a lie, or the easy task of detecting a failure to provide a factual answer based on user facts. In some embodiments, these open-ended challenges can be combined with public knowledge, e.g. if a user having intent to harm the protected system describes a morning commute as enjoyable, that would be inconsistent with a major accident and delay on the path of the actual user's travel.

FIG. 1G depicts an illustrative embodiment of a method in accordance with various aspects described herein. FIG. 1G illustrates a method 50 for determining system security risk activity patterns, as executed by a processing system. The method begins with Step 52, where user activity data of a target user within a protected system is collected. This data is gathered using a variety of sources, including biometric sensors, applications used by the target user, devices operated by the target user, network access by the target user, and responses to questions tailored to the target user.

In Step 53 of the method 50, the collected user activity data is evaluated against predefined patterns stored in one or more databases. These patterns include a group of positive patterns, which indicate no intent to harm the protected system, and a group of negative patterns, which suggest intent to harm the system. The negative patterns are determined based on publicly known historical data and user-specific historical data related to harming computing systems.

The method 50 further includes generating one of at least three codes—indicative of acceptance, quarantine, or rejection of the target user—based on the evaluation of the user activity data (Step 55). In Step 56 of the method 50, the one of at least three codes are dynamically adjusted as the user activity data changes over time. Finally, Step 57 of the method 50 involves taking action based on the generated codes, which includes accepting, blocking, or quarantining access of the target user to the protected system.

In one or more embodiments, the method 50 further includes generating notifications to inform users, system administrators, security teams, and management of the generated codes. These notifications provide alerts about identified risks and specify actions to mitigate identified threats to the protected system. Additionally, the method 50 involves capturing environmental context data, such as location, time of day, and recent system updates, to enhance the evaluation of the user activity and provide a comprehensive assessment of security risks to the protected system. The method 50 employs a feedback loop to refine the predefined patterns based on historical outcomes and new threat information. Furthermore, the method 50 incorporates user feedback on false positives and negatives to dynamically update predetermined thresholds for acceptance, quarantine, and rejection, enhancing the system's adaptability to evolving user behavior patterns. The method 50 also includes using biometric sensors to capture physiological data of the target user, such as fingerprints, facial recognition, heart rate, or a combination thereof, to enhance the evaluation of the user activity.

In one or more embodiments, the processing system within the method 50 employs an artificial intelligence/machine learning (AI/ML) model, including a large language model (LLM), to generate questions tailored to the target user, enabling the creation of personalized queries that provide insights into the target user's intent and emotional state through analysis of the answers provided. The method 50 adjusts the codes from the quarantine code to the acceptance code based on the responses to the questions, wherein the responses are correlated to a match between the user behavior data and one or more of the group of negative patterns. Additionally, the method 50 adjusts the codes from the quarantine code to the rejection code based on the responses, wherein the responses do not impact a match between the user behavior data and one or more of the group of negative patterns.

While for purposes of simplicity of explanation, the respective processes are shown and described as a series of blocks in FIG. 1G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described above, the systems and methods for determining system security risk activity patterns are configured to merge behavioral analysis with technical infrastructure, thereby leveraging human behaviors and integrating into an adaptive security system. The systems and methods integrate psychological case studies, vetted data, and instructional formats to develop an advanced, adaptive application capable of learning and responding to both human and software-driven behaviors. The process enhances security through periodic computation of variable key codes based on humanistic behavioral theories. By generate dynamic security codes based on behavioral patterns, e.g., codes indicative of acceptable, unacceptable, and questionable, the systems and methods facilitate adaptive and robust protection. This continuous analysis and response mechanism offers real-time defense against emerging threats, elevating the security landscape.

The systems and methods further facilitate adaptive security which continuously evolves with user interactions, making it more resilient to emerging threats. Unlike current security systems primarily rely on static protocols and predefined algorithms, which can be predictable and easier to breach, the systems and methods utilize a dynamic, behavior-based security model that evolves with the user's interaction patterns, making it significantly harder for malicious actors to predict or exploit.

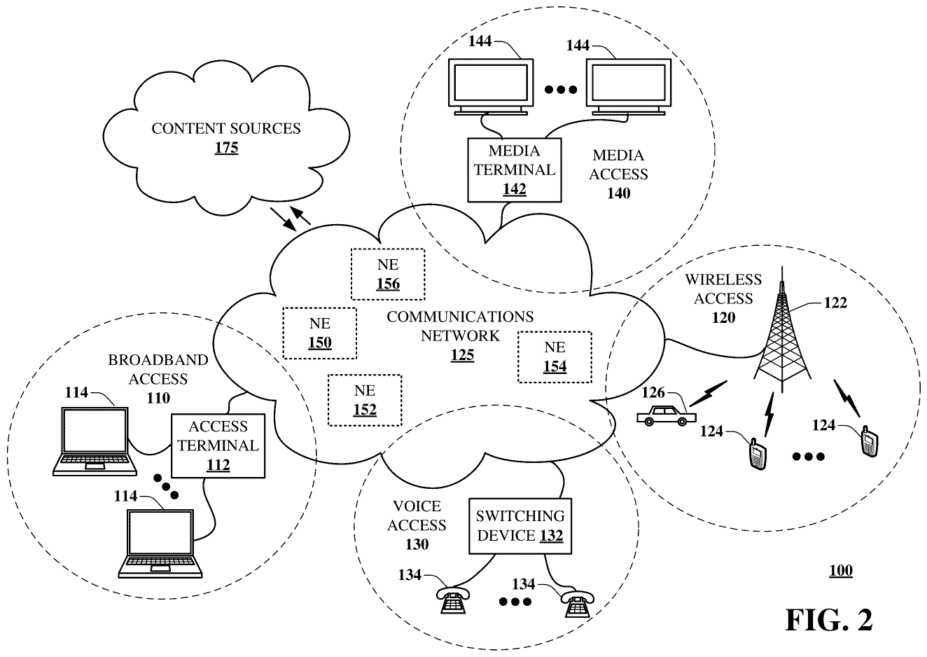

Referring now to FIG. 2, a block diagram is shown illustrating an example, non-limiting embodiment of a system 100 in accordance with various aspects described herein. For example, system 100 can facilitate in whole or in part systems and methods for determining system security risk activity patterns. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

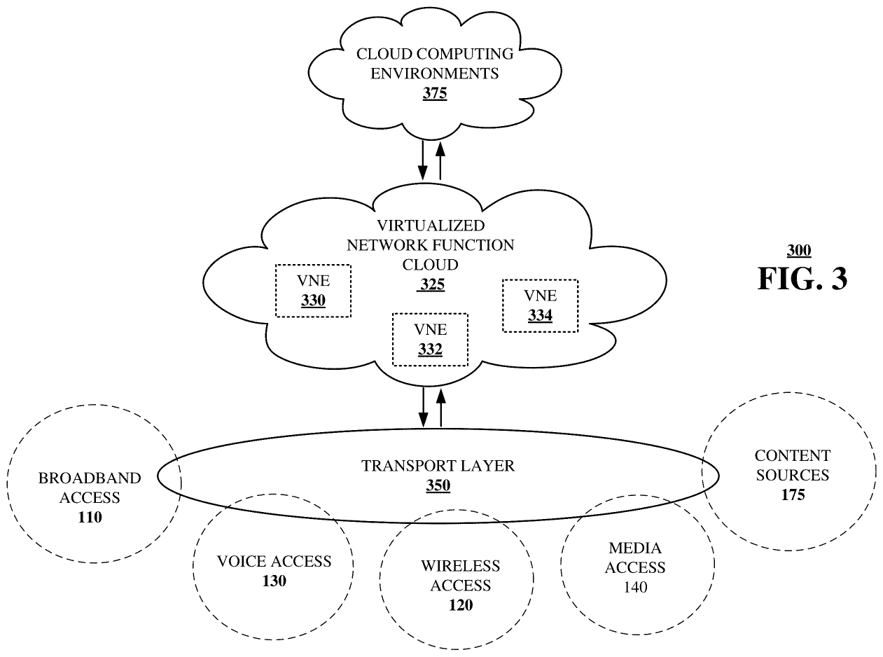

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 10, 30, 100, and method 50 presented in FIGS. 1D, 1F, 1G, and 2. For example, virtualized communication network 300 can facilitate in whole or in part systems and methods for determining system security risk activity patterns.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

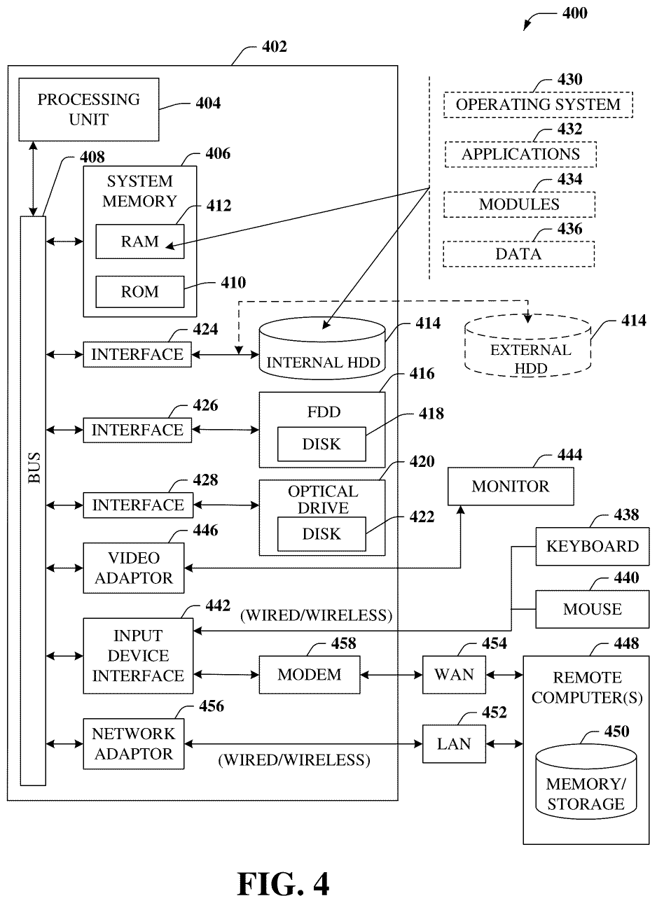

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods for determining system security risk activity patterns.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a system-wide communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

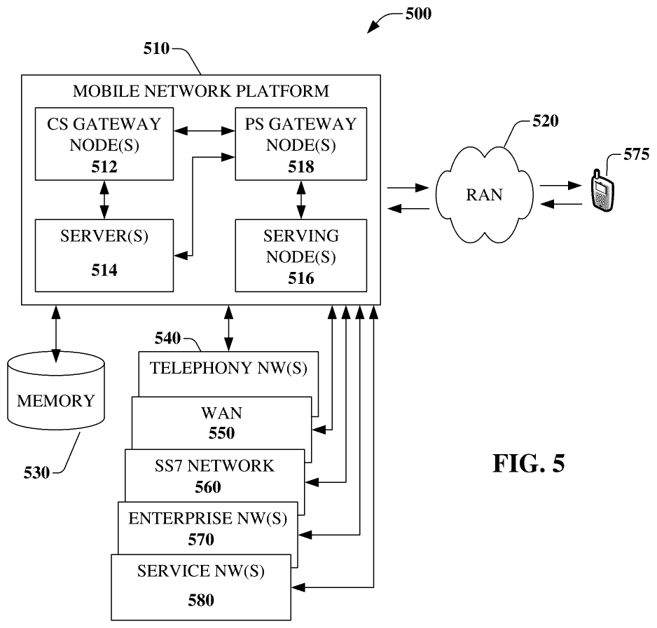

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods for determining system security risk activity patterns. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or System-wide Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

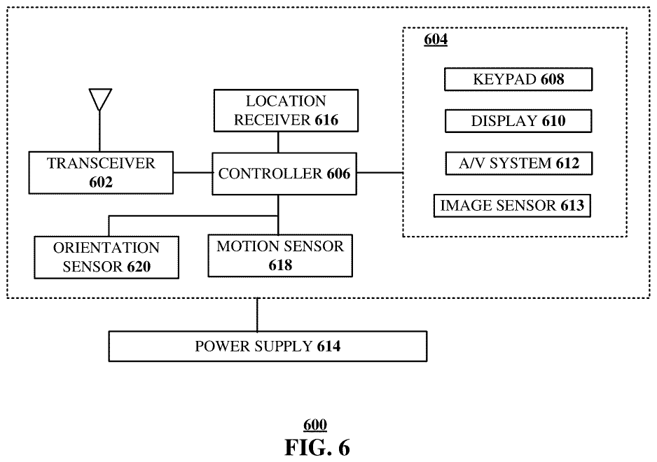

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods for determining system security risk activity patterns.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a system-wide positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a plurality of sensors including biometric sensors operable to generate sensor output for a target user including a facial image, a fingerprint, a body temperature, a heartbeat rate, a movement speed, or a combination thereof, wherein the target user is an admitted user to a protected system by presenting a required credential for verification;
a processing system coupled to the plurality of sensors and including a processor and a memory storing executable instructions that, when executed by the processor, facilitate performance of operations, the operations comprising:
collecting user behavior data of the target user corresponding to user behavior within the protected system during a predetermined time period, using the plurality of sensors including the biometric sensors and one or more usage patterns of the protected system;
evaluating the user behavior data of the target user against predefined patterns stored in one or more databases, wherein the predefined patterns include a group of positive patterns indicative of no intent to harm the protected system and a group of negative patterns indicative of intent to harm the protected system, and wherein the group of negative patterns are determined based on publicly known historical data and user-specific historical data relating to harming computing systems;
generating one of at least three codes indicative of acceptance, quarantine, and rejection of the target user based on the evaluation of the user behavior data;
adjusting the codes dynamically as the user behavior data changes over time; and
based on the generated one of the at least three codes, accepting, blocking, or quarantining access of the target user to the protected system.

2. The system of claim 1, wherein the one or more usage patterns of the protected system further include:
applications used by the target user, capturing data related to software and tools accessed by the target user within the protected system;
one or more devices used by the target user, including data from hardware interactions and device-specific activities performed by the target user; and
a network access by the target user, encompassing data related to target user's connectivity, including IP addresses, bandwidth usage, and access points.

3. The system of claim 1, wherein the processing system further includes:
providing insights into target user's intent and emotional state through personalized queries and analysis of answers provided.

4. The system of claim 3, wherein the processing system employs an artificial intelligence/machine learning (AI/ML) model to generate the personalized queries tailored to the target user, enabling creation of personalized queries that provide insights into the target user's intent and emotional state through analysis of the answers provided, and wherein the AI/ML model includes a large language model (LLM).

5. The system of claim 3, wherein the adjusting of the codes includes adjusting the codes from a quarantine code to an acceptance code based on the answers to the personalized queries, wherein the answers are correlated to a match between the user behavior data and one or more of the group of negative patterns.

6. The system of claim 3, wherein the adjusting of the codes includes adjusting the codes from a quarantine code to a rejection code based on the answers, wherein the answers are not correlated to a match between the user behavior data and one or more of the group of negative patterns.

7. The system of claim 1, wherein the evaluation of the user behavior data includes:
determining a first count of matches between the user behavior data of the target user and the group of negative patterns;
determining a second count of matches between the user behavior data of the target user and the group of positive patterns; and
determining that the first count outweighs the second count.

8. The system of claim 7, wherein each of the group of negative patterns is assigned with two or more first predetermined weights and each of the group of positive patterns is assigned with two or more second predetermined weights, and
wherein the operations further comprise:
determining a first weighted value of the first count of matches;
determining a second weighted value of the second count of matches; and
determining that the first weighted value is greater than the second weighted value.

9. The system of claim 1, wherein the generating of the one of at least three codes and the adjusting of the codes dynamically occurs during a same computing session by the target user interacting with the protected system, wherein the group of negative patterns includes unusual access attempts, rapid data extraction, interactions with suspicious files or application program interfaces (APIs), exploitation of known system vulnerabilities, a use of automated tools to perform actions that mimic legitimate user behavior but at an atypical scale or speed, or a combination thereof.

10. The system of claim 1, wherein the group of positive patterns includes normal resource usage, standard login procedures, typical access patterns, regular interaction timelines, consistent network behavior, or a combination thereof.

11. A non-transitory machine-readable medium, comprising executable instructions that, when executed by a processing system including a processor, facilitate performance of operations, the operations comprising:
collecting user activity data of a target user within a protected system, using a plurality of sensors including biometric sensors, one or more applications used by the target user, one or more devices used by the target user, a network access by the target user, and based on responses by the target user to questions tailored to the target user;
evaluating the user activity data of the target user against predefined patterns stored in one or more databases, wherein the predefined patterns include a group of positive patterns indicative of no intent to harm the protected system at a system-wide level and a per-user level, and a group of negative patterns indicative of intent to harm the protected system at the system-wide level and the per-user level, and wherein the group of negative patterns are determined based on publicly known historical data and user-specific historical data relating to harming computing systems;
generating one of at least three codes indicative of acceptance, quarantine, and rejection of the target user based on the evaluation of the user activity data;
adjusting the codes dynamically as the user activity data changes over time; and
based on the generated one of at least three codes, accepting, blocking, or quarantining access of the target user to the protected system.

12. The non-transitory machine-readable medium of claim 11, wherein the plurality of sensors includes biometric sensors configured to capture physiological data of the target user, including fingerprints, facial recognition, heart rate, or a combination thereof, to enhance the evaluation of the user activity data.

13. The non-transitory machine-readable medium of claim 11, wherein the processing system employs an artificial intelligence/machine learning (AI/ML) model to generate the questions tailored to the target user, and wherein the AI/ML model includes a large language model (LLM) to create context-aware and insightful queries.

14. The non-transitory machine-readable medium of claim 11, wherein the adjusting of the codes includes adjusting the codes from a quarantine code to an acceptance code based on the responses to the questions, wherein the responses are correlated to a match between the user activity data and one or more of the group of negative patterns.

15. The non-transitory machine-readable medium of claim 11, wherein the adjusting of the codes includes adjusting the codes from a quarantine code to a rejection code based on the responses, wherein the responses do not impact a match between the user activity data and one or more of the group of negative patterns.

16. A method,
comprising:
collecting, by a processing system including a processor, user activity data of a target user within a protected system, using a plurality of sensors including biometric sensors, one or more applications used by the target user, one or more devices used by the target user, a network access by the target user, and based on responses by the target user to questions tailored to the target user;
evaluating, by the processing system, the user activity data of the target user against predefined patterns stored in one or more databases, wherein the predefined patterns include a group of positive patterns indicative of no intent to harm the protected system at a system-wide level and a per-user level, and a group of negative patterns indicative of intent to harm the protected system at the system-wide level and the per-user level, and wherein the group of negative patterns are determined based on publicly known historical data and user-specific historical data relating to harming computing systems, wherein the evaluating further comprises determining a match among the user activity data and the group of negative patterns and the group of positive patterns;
generating, by the processing system, one of at least three codes indicative of acceptance, quarantine, and rejection of access of the target user to the protected system, based on the evaluation of the user activity data;
adjusting, by the processing system, the one of at least three codes dynamically as the user activity data changes over time; and
based on the generated one of at least three codes, accepting, blocking, or quarantining, by the processing system, the access of the target user to the protected system.

17. The method of claim 16, further comprising generating notifications, by the processing system, to inform users, system administrators, security teams, management of the generated one of at least three codes, or a combination thereof, wherein the notifications provide alerts about identified risks and specify actions to mitigate identified threats to the protected system.

18. The method of claim 16, wherein the collecting of data further includes capturing, by the processing system, environmental context data including location, time of a day, and latest system updates.

19. The method of claim 16, further comprising employing, by the processing system, a feedback loop to refine the predefined patterns based on historical outcomes and new threat information.

20. The method of claim 16, wherein the adjusting of the codes further includes:
incorporating user feedback on false positives and false negatives; and
dynamically updating predetermined thresholds for generating the one of at least three codes indicative of the acceptance, the quarantine, and the rejection.
